(19) United States
(12) Patent Application Publication
(10) Pub. No.: US 2014/0083604 A1
(43) Pub. Date: Mar. 27, 2014

(54) MULTILAYER POLYMERIC ARTICLES AND METHODS FOR MAKING SAME

(71) Applicants: Emilie Gautriaud, Marlborough, MA (US); Fabrice Abbott, UCCLE (BE); Mark W. Simon, Pascoag, RI (US); Duan Li Ou, Watchung, NJ (US); Christopher G. Robertson, Akron, OH (US); Adam Paul Nadeau, Hudson, MA (US)

(72) Inventors: Emilie Gautriaud, Marlborough, MA (US); Fabrice Abbott, UCCLE (BE); Mark W. Simon, Pascoag, RI (US); Duan Li Ou, Watchung, NJ (US); Christopher G. Robertson, Akron, OH (US); Adam Paul Nadeau, Hudson, MA (US)

(73) Assignee: SAINT-GOBAIN PERFORMANCE PLASTICS CORPORATION, Aurora, OH (US)

(21) Appl. No.: 14/092,047

(22) Filed: Nov. 27, 2013

Related U.S. Application Data
(63) Continuation of application No. 12/651,361, filed on Dec. 31, 2009.
(60) Provisional application No. 61/141,801, filed on Dec. 31, 2008.

(51) Int. Cl. B29C 47/06; B29C 45/16; B29C 65/00

(52) U.S. Cl. CPC B29C 47/06; B29C 65/002; B29C 45/1657
USPC 156/244.17; 156/273.3; 156/245

(57) ABSTRACT

A polymeric article may include a first layer and a second layer directly contacting the first layer. The first layer may include a low surface energy polymer and may have a contact index of at least 5%. The second layer may include an elastomer.

### CROSS REFERENCE TO RELATED APPLICATION(S)

The present application claims priority under 35 U.S.C. §120 and is a continuation from U.S. patent application Ser. No. 12/651,361 entitled “MULTILAYER POLYMERIC ARTICLES AND METHODS FOR MAKING SAME” by Emilie Gautriaud et al., filed Dec. 31, 2009, which claims priority under 35 U.S.C. §119 (e) to U.S. Provisional Patent Application No. 61/141,801 entitled “MULTILAYER POLYMERIC ARTICLES AND METHODS FOR MAKING SAME,” by Emilie Gautriaud et al., filed Dec. 31, 2008. Each patent application cited herein is hereby incorporated by reference in its entirety.

### FIELD OF THE DISCLOSURE

This application in general, relates to multilayer polymeric articles having high peel strength and methods for making same, and in particular, relates to multilayer fluid conduits.

### BACKGROUND

Sanitary hoses are used in a variety of industries including food processing, chemical industries, and pharmaceutical industries. In such industries, fluid conduits that have a low surface energy inner surface are used because they are easy to clean and biological contaminates, such as bacteria, have difficulty adhering to such surfaces. In particular, such industries are turning to low surface energy polymers such as fluoropolymers. However, such fluoropolymers are expensive and are often inflexible.

Accordingly, industry uses such fluoropolymers as liners within elastomeric fluid conduit. However, the low surface energy nature of fluoropolymers desirable as an inner surface also provides poor bonding to elastomers. To enhance the bonding of fluoropolymers to various elastomers, industry has turned to the use of intermediate adhesive layers or chemical surface treatment techniques. The use of adhesives adds additional processing to hose manufacturing, often provides little improvement in peel strength, and introduces leachable species into the polymeric article. In addition, industry has turned to such techniques as chemical etching. However, such techniques often decrease the hydrophobicity of the surfaces, increase the surface energy on the surfaces, and create undesirable byproducts that may leach into process fluids.

In particular, leachable species may contaminate products, such as food or pharmaceutical products. Moreover, particular species may react to spoil or discolor products, and even further, partially fluorinated species may pose a health risk when found in food products or pharmaceuticals.

As such, an improved multilayer polymer article would be desirable.

### SUMMARY

In an embodiment, a method of forming a polymeric article includes dispensing a first polymer layer comprising a low surface energy polymer and having a bond surface prepared with a directed energizing treatment. The method further includes applying a second polymer layer to directly contact the bond surface. The second polymer layer includes an elastomer or thermoplastic.

In a particular embodiment, a polymeric article includes a first layer and a second layer directly contacting the first layer. The first layer includes a low surface energy polymer and has a contact index of at least 5%, as defined in the body. The second layer includes an elastomer.

In another exemplary embodiment, a polymeric article includes a first polymer layer having first and second surfaces. The first polymer layer includes a low surface energy polymer. The first surface is substantially free of oxygenated species. The polymeric article further includes a second polymer layer in direct contact with the first surface of the first polymer layer. The second polymer layer includes an elastomer. The polymeric article has a peel strength of at least 7 ppi.

In a further exemplary embodiment, a polymeric article includes a first layer having first and second surfaces. The first layer includes a low surface energy polymer. The first surface has a tufted morphology. The polymeric article further includes a second layer directly contacting the first surface. The second layer includes an elastomer. The polymeric article has a peel strength of at least 7 ppi.

In an addition embodiment, a method of forming a polymeric article includes dispensing a first polymer layer comprising a low surface energy polymer and having a bond surface prepared with a directed energizing treatment, and applying a second polymer layer to directly contact the bond surface. The second polymer layer includes an elastomer.

In another exemplary embodiment, a fluid conduit includes an inner layer including a low surface energy polymer and having a contact index of at least 5%. The fluid conduit also includes a second layer directly contacting and radially overlying the first layer. The second layer includes an elastomer.

In a further exemplary embodiment, a fluid conduit includes an inner layer having an inner surface and an outer surface. The inner layer includes a low surface energy polymer. The outer surface is substantially free of oxygenated species. The fluid conduit also includes a second polymer layer in direct contact with the outer surface of the inner layer. The second polymer layer includes an elastomer. The polymeric article has a peel strength of at least 7 ppi.

In an additional embodiment, a fluid conduit includes an inner layer having an inner surface and an outer surface. The inner layer includes a low surface energy polymer. The outer surface has a tufted morphology. The fluid conduit further includes a second layer directly contacting the outer surface of the inner layer. The second layer includes an elastomer. The polymeric article has a peel strength of at least 7 ppi.

In another exemplary embodiment, a method of forming a fluid conduit includes dispensing an inner layer. The inner layer includes a low surface energy polymer and has a bond surface prepared with a directed energizing treatment. The method further includes applying a second polymer layer to directly contact the bond surface. The second polymer layer includes an elastomer.

In a particular embodiment, a polymeric article includes a first layer and a second layer directly contacting the first layer. The first layer includes a low surface energy polymer and has a contact index of at least 5. The second layer includes a thermoplastic polymer.

In another exemplary embodiment, a polymeric article includes a first polymer layer having first and second surfaces. The first polymer layer includes a low surface energy polymer. The first surface is substantially free of oxygenated species. The polymeric article further includes a second polymer layer in direct contact with the first surface of the first polymer layer. The second polymer layer includes a thermoplastic polymer. The polymeric article has a peel strength of at least 7 ppi.

In a further exemplary embodiment, a polymeric article includes a first layer having first and second surfaces. The first layer includes a low surface energy polymer. The first surface has a tufted morphology. The polymeric article further includes a second layer directly contacting the first surface. The second layer includes a thermoplastic polymer. The polymeric article has a peel strength of at least 7 ppi.

In an addition embodiment, a method of forming a polymeric article includes dispensing a first polymer layer comprising a low surface energy polymer and having a bond surface prepared with a directed energizing treatment, and applying a second polymer layer to directly contact the bond surface. The second polymer layer includes a thermoplastic polymer.

In another exemplary embodiment, a fluid conduit includes an inner layer including a low surface energy polymer and having a contact index of at least 5%. The fluid conduit also includes a second layer directly contacting and radially overlying the first layer. The second layer includes a thermoplastic polymer.

In a further exemplary embodiment, a fluid conduit includes an inner layer having an inner surface and an outer surface. The inner layer includes a low surface energy polymer. The outer surface is substantially free of oxygenated species. The fluid conduit also includes a second polymer layer in direct contact with the outer surface of the inner layer. The second polymer layer includes a thermoplastic polymer. The polymeric article has a peel strength of at least 7 ppi.

In an additional embodiment, a fluid conduit includes an inner layer having an inner surface and an outer surface. The inner layer includes a low surface energy polymer. The outer surface has a tufted morphology. The fluid conduit further includes a second layer directly contacting the outer surface of the inner layer. The second layer includes a thermoplastic polymer. The polymeric article has a peel strength of at least 7 ppi.

In another exemplary embodiment, a method of forming a fluid conduit includes dispensing an inner layer. The inner layer includes a low surface energy polymer and has a bond surface prepared with a directed energizing treatment. The method further includes applying a second polymer layer to directly contact the bond surface. The second polymer layer includes a thermoplastic polymer.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary polymeric article.

FIG. 2 and FIG. 3 include illustrations of exemplary hoses.

FIG. 4, FIG. 5 and FIG. 6 include illustrations of exemplary deionized water droplets on various surfaces.

FIG. 7 includes an illustration of FTIR spectra for treated surfaces.

FIG. 8, FIG. 9, FIG. 10, FIG. 11, and FIG. 12 include illustrations of exemplary untreated and treated surfaces.

FIG. 13, FIG. 14, FIG. 15, and FIG. 16 include illustrations of FTIR spectra for treated surfaces.

FIG. 17 includes a graph of peel strength as a function of UV exposure time.

FIG. 18 includes an illustration of exemplary deionized water droplets on a UV laser treated surface.

FIG. 19 includes an illustration of an exemplary UV treated surface.

FIG. 20 and FIG. 21 include illustrations of treated surfaces after dissolution of an elastomer previously bonded to the treated surfaces.

FIG. 22 and FIG. 23 include illustrations of cross-sections of films formed from treated fluoropolymers.

FIG. 24 includes an illustration of a treated surface of a PTFE tube.

The use of the same reference symbols in different drawings indicates similar or identical items.

### DESCRIPTION OF THE PREFERRED EMBODIMENT(S)

In a particular embodiment, a polymeric article includes a first layer formed of a fluoropolymer and a second layer formed of an elastomer or a thermoplastic polymer that directly contacts the first layer. In an example, the first layer includes a fluoropolymer, such as a perfluoropolymer, for example, polytetrafluoroethylene (PTFE) or fluorinated ethylene propylene (FEP). A bond surface on the first layer is treated with a directed energizing treatment. In particular, the second layer is directly bonded to the first layer without intervening layers. Advantageously, the peel strength exhibited between the first layer and the second layer is at least about 7 pounds per inch (ppi), such as at least 10 ppi. In an embodiment, the polymer article may take the form of a fluid conduit, such as a hose. In an example, the first layer forms an inner liner of the fluid conduit.

In another exemplary embodiment, a method of forming a polymeric article, such as a fluid conduit, includes dispensing a first layer formed of a fluoropolymer. The first layer is treated with a directed energizing treatment. The method further includes applying a second layer over the first layer. The second layer may include an elastomer. In addition, the method may include treating a surface of the first layer with an ion beam treatment, such as a non-reactive ion beam treatment, for example using a noble gas. In an example, the noble gas is argon.

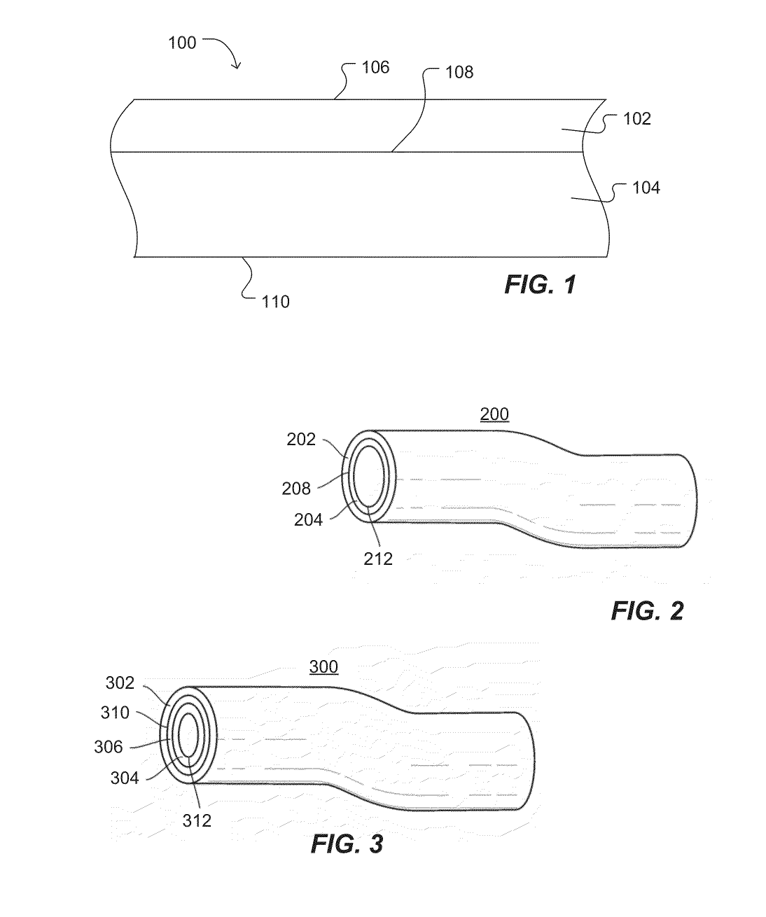

In an exemplary embodiment, the polymeric article may include multiple layers, such as at least two layers. For example, the polymer article may be a multiple layer film or a multiple layer fluid conduit, such as a tube or hose. In an example, FIG. 1 includes an illustration of an exemplary polymer article 100 that has at least two layers. For example, a first layer 102 may be bonded to a second layer 104. In particular, the first and second layers (102, 104) are in direct contact absent any intervening layers, such as adhesive layers, particularly epoxy-based, cyanurate, polyurethane, or cyanoacrylate-based adhesives or deposited metal layers.

The first layer 102 may include a first surface 106 and a second surface 108. In an example, at least the second surface 108 is treated with a directed energizing treatment. The second layer 104 includes an elastomer or a thermoplastic polymer and directly contacts the second surface 108 of the first layer 104.

In a particular example, the first layer 102 includes a low surface energy polymeric material. An exemplary low surface energy polymer may include a fluoropolymer, a silicone polymer, or a combination thereof. For example, the first layer 102 may include a fluoropolymer. An exemplary fluoropolymer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. An exemplary fluoropolymer includes polytetrafluoroethylene (PTFE), a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), poly vinylidene fluoride (PVDF), a terpolymer including tetrafluoroethylene, hexafluoropropylene, and vinylidenefluoride (THV), polyvinyl fluoride (PVF, e.g., Tedlar™), a terpolymer of tetrafluoroethylene, hexafluoroproplyene, and ethylene, or any blend or any alloy thereof. In an example, the fluoropolymer includes polytetrafluoroethylene (PTFE), fluorinated ethylene propylene (FEP), PFA, polyvinylidene fluoride (PVDF), polyvinyl fluoride (PVF, e.g., Tedlar™), or any combination thereof. In particular, the fluoropolymer may include polytetrafluoroethylene (PTFE), fluorinated ethylene propylene (FEP), PFA, or any combination thereof. In a further embodiment, the fluoropolymer may be a perfluoropolymer, such as PTFE or FEP. In a particular example, the fluoropolymer may include PTFE, such as a skived PTFE, a paste extruded PTFE, a ram extruded PTFE, an expanded PTFE, cast PTFE, or a heat shrinkable PTFE.

In a further embodiment, the first layer may be formed of a composite material including the low surface energy polymer as a polymer matrix and a filler. For example, the filler may include such as a solid lubricant, a ceramic or mineral, a polymer filler, a fiber filler, a metal particulate filler, or any combination thereof. An exemplary solid lubricant includes polytetrafluoroethylene, molybdenum disulfide, tungsten disulfide, graphite, graphene, expanded graphite, or any combination thereof. An exemplary ceramic or mineral includes alumina, silica, titanium dioxide, calcium fluoride, boron nitride, mica, Wollastonite, silicon carbide, silicon nitride, zirconia, carbon black, pigments, or any combination thereof. An exemplary polymer filler includes polyimide, Ekonol® polyester, polybenzimidazole, any of the thermoplastic polymers listed above, or any combination thereof. An exemplary fiber includes nylon fibers, glass fibers, carbon fibers, polyacrylonitrile fibers, polyaramid fibers, polytetrafluoroethylene fibers, basalt fibers, graphite fibers, ceramic fibers, or any combination thereof. Exemplary metals include bronze, copper, stainless steel, or any combination thereof.

In a particular embodiment, the first layer 102 includes at least 70% by weight of the fluoropolymer. For example, the first layer 102 may include at least 85% by weight fluoropolymer, such as at least 90% by weight, at least 95% by weight, or even 100% by weight of the fluoropolymer. In an example, the first layer 102 may consist essentially of fluoropolymer.

In an example, the fluoropolymer has desirable mechanical properties, such as a desirable elongation-at-break. The elongation-at-break of the first layer 102 as measured based on the modified ASTM D638 type 5 testing method may be at least about 250%, such as at least about 300%, or even at least about 400%.

One or more surfaces of the first layer 102 may be treated with a directed energizing treatment, which is a treatment characterized by a directed stream of energy in the form of photons, electrons, or ions. For example, the directed energizing treatment may include an energy beam treatment, such as a laser, for example, an excimer laser. In an example, the excimer laser is a UV pulsed ArF excimer laser. In another example, the directed energizing treatment includes treatment with a particle source, such as an e-beam source or an ion beam source. In particular, the particle source provides particles that move in substantially the same direction with substantially the same energy. For example, the treatment may include an ion beam treatment, such as a reactive ion beam treatment or a non-reactive ion beam treatment. In an example, the reactive ion beam treatment includes treatments with a reactive gas including, for example, oxygen, nitrogen, hydrogen, or any combination thereof. The reactive gas may or may not include a noble gas in addition to the reactive gas. In a particular example, a non-reactive ion beam treatment may include treatment with ionized noble gas, such as ionized argon. In contrast, the directed energizing treatment is not corona treatment or conventional plasma treatment. In a particular example, the surface 108 is treated prior to contact with the second layer 104.

The second layer 104 may include a polymer material, such as a thermoplastic material or an elastomer material. As used herein, a thermoplastic material or an elastomer material does not include epoxy, polyurethane, cyanurate, or cyanoacrylate adhesive. An exemplary polymer includes a polyolefin, a polycarbonate, a polyurethane, an acrylate, a polyamide, a polyimide, a diene elastomer, a silicone polymer, a polystyrene, a polyester (e.g., poly ethylene terephthalate), a poly alkyl halide, such as poly vinyl chloride, a thermoplastic fluoropolymer, ethylene vinyl acetate (EVA), ionomers, modified polyolefins, or any combination thereof. For example, the polymer may include a thermoplastic polymer, such as a polyolefin, a polycarbonate, a polyamide, a thermoplastic polyimide, thermoplastic polyurethane, polyester, thermoplastic fluoropolymer, an acrylate, or any combination thereof. In an example, the polyolefin includes polyethylene, polypropylene, a copolymer of ethylene with an α-olefin, a copolymer of propylene with an α-olefin, a copolymer of ethylene and propylene, or a combination thereof. In another example, an acrylate includes ethylene methacrylate, ethylene butyl acrylate, poly methyl methacrylate, or any combination thereof. In a further example, the thermoplastic fluoropolymer includes PVDF or a modified PVDF, such as those polymers available under the tradename Kynar™ or KynarFlex™, ETFE, FEP, PFA, THV, or any combination thereof. In another example, the polymer material is an elastomer. In an example, the elastomer is selected from a diene elastomer, a thermoplastic urethane, a thermoplastic olefinic elastomer, a silicone elastomer, or any combination thereof. In particular, the elastomer can be a curable elastomer. Any one of the thermoplastic polymers or elastomers may be rendered self-bonding through additives or modification.

In a particular example, the elastomer includes a diene elastomer that may be partially or fully hydrogenated. In another embodiment, the elastomeric material includes a crosslinkable elastomeric polymer. For example, the elastomeric material may include a diene elastomer. In a particular example, the elastomeric material may include a blend of a diene elastomer and a polyolefin. The diene elastomer may be a copolymer formed from at least one diene monomer. For example, the diene elastomer may be a copolymer of ethylene, propylene and diene monomer (EPDM). An exemplary diene monomer may include a conjugated diene, such as butadiene, isoprene, chloroprene, or the like; a non-conjugated diene including from 5 to about 25 carbon atoms, such as 1,4-pentadiene, 1,4-hexadiene, 1,5-hexadiene, 2,5-dimethyl-1,5-hexadiene, 1,4-octadiene, or the like; a cyclic diene, such as cyclopentadiene, cyclohexadiene, cyclooctadiene, dicyclopentadiene, or the like; a vinyl cyclic ene, such as 1-vinyl-1-cyclopentene, 1-vinyl-1-cyclohexene, or the like; an alkylbicyclononadiene, such as 3-methylbicyclo-(4,2,1)-nona-3,7-diene, or the like; an indene, such as methyl tetrahydroindene, or the like; an alkenyl norbornene, such as 5-ethylidene-2-norbornene, 5-butylidene-2-norbornene, 2-methallyl-5-norbornene, 2-isopropenyl-5-norbornene, 5-(1,5-hexadienyl)-2-norbornene, 5-(3,7-octadienyl)-2-norbornene, or the like; a tricyclodiene, such as 3-methyltricyclo (5,2,1,0²,6)-deca-3,8-diene or the like; or any combination thereof. In a particular embodiment, the diene includes a non-conjugated diene. In another embodiment, the diene elastomer includes alkenyl norbornene. The diene elastomer may include, for example, ethylene from about 63.0 wt % to about 95.0 wt % of the polymer, propylene from about 5.0 wt % to about 37.0 wt %, and the diene monomer from about 0.2 wt % to about 15.0 wt %, based upon the total weight of the diene elastomer. In a particular example, the ethylene content is from about 70.0 wt % to about 90.0 wt %, propylene from about 17.0 wt % to about 31.0 wt %, and the diene monomer from about 2.0 wt % to about 10.0 wt % of the diene elastomer. Prior to crosslinking, the diene elastomer may have a green tensile strength of about 800 psi to about 1,800 psi, such as about 900 psi to about 1,600 psi. The uncrosslinked diene elastomer may have an elongation-at-break of at least about 600 percent. In general, the diene elastomer includes a small amount of a diene monomer, such as a dicyclopentadiene, a ethylnorbornene, a methylnorbornene, a non-conjugated hexadiene, or the like, and typically have a number average molecular weight of from about 50,000 to about 100,000. Exemplary diene elastomers are commercially available under the tradename Nordel™ from Dow Dupont. Diene elastomers may also be formed of copolymer of a diene, such as acrylonitrile-butadiene-styrene (ABS), styrene-butadiene-styrene (SBS), or other diene copolymer, or any combination thereof.

When incorporated as a blend with a diene elastomer, the polyolefin of the blend may include a homopolymer, a copolymer, a terpolymer, an alloy, or any combination thereof formed from a monomer, such as ethylene, propylene, butene, pentene, methyl pentene, octene, or any combination thereof. An exemplary polyolefin includes high density polyethylene (HDPE), medium density polyethylene (MDPE), low density polyethylene (LDPE), ultra low density polyethylene, ethylene propylene copolymer, ethylene butene copolymer, polypropylene (PP), polybutene, polypentene, polymethylpentene, ethylene propylene rubber (EPR), ethylene octene copolymer, or any combination thereof. In a particular example, the polyolefin includes high density polyethylene. In another example, the polyolefin includes polypropylene. In a further example, the polyolefin includes ethylene octene copolymer. In a particular embodiment, the polyolefin is not a modified polyolefin, such as a carboxylic functional group modified polyolefin, and in particular, is not ethylene vinyl acetate. In addition, the polyolefin is not formed from a diene monomer. In a particular example, the polyolefin has a degree of crystallinity. For example, the polyolefin may have at least about 35% crystallinity. In a particular example, the polyolefin may have a crystallinity of at least about 50%, such as at least about 60% or at least about 70% crystallinity. Alternatively, the polyolefin may be a low crystallinity polyolefin, having a crystallinity not greater than 35%. Low crystallinity polyolefins may improve clarity in particular applications. An exemplary commercially available polyolefin includes Equistar 8540, an ethylene octene copolymer; Equistar GA-502-024, an LLDPE; Dow DMDA-8904NT 7, an HDPE; Basell Pro-Fax SR275M, a random polypropylene copolymer; Dow 7C50, a block PP copolymer; or products formerly sold under the tradename Engage by Dupont Dow.

In an example, a diene elastomer may be blended with a polyolefin. For example, the blend may include not greater than about 40.0 wt % polyolefin, such as not greater than about 30.0 wt % polyolefin. For example, the blends may include not greater than about 20.0 wt % of the polyolefin, such as not greater than 10.0 wt %. In a particular example, the blend includes about 5.0 wt % to about 30.0 wt %, such as about 10.0 wt % to about 30.0 wt %, about 10.0 wt % to about 25.0 wt %, or about 10.0 wt % to about 20.0 wt % of the polyolefin. Alternatively, a polyolefin as identified above may be used without blending and may form 100% of the polymer content of the second layer 104.

In a further example, the elastomer includes a copolymer or crosslinked blend of EPDM and a polyolefin. For example, an exemplary commercial EPDM/polyolefin blend includes polymers available under the tradename Santoprene™, available from Advanced Elastomer Systems.

In a particular example, the elastomer, such as the blend, is self-bonding. For self-bonding elastomers, a modification to the elastomer, either through grafting chemically active functionalities onto the polymeric chains within the elastomer or through incorporation of a separated chemical component into the matrix of the elastomer, leads to enhanced bonding between the elastomer and a substrate in a multilayer article. For example, the blend may be a self-bonding Santoprene™.

In an additional example, the elastomer may include styrene-based elastomers. For example, the elastomer may include polystyrene, or a styrene copolymer, such as styrene-ethylene-butylene-styrene polymer (SEBS), acrylonitrile-butadiene-styrene (ABS), styrene-butadiene (SBR), or blends or copolymers thereof. In a particular example, the elastomer includes a blend of SEBS and polypropylene, such as C-Flex®, available from Saint-Gobain Performance Plastics Corporation.

In an exemplary embodiment, the elastomer may be cured through cross-linking. In a particular example, the elastomer may be cross-linkable through heat treatment or through radiation, such as using x-ray radiation, gamma radiation, ultraviolet electromagnetic radiation, visible light radiation, electron beam (e-beam) radiation, or any combination thereof. Ultraviolet (UV) radiation may include radiation at a wavelength or a plurality of wavelengths in the range of from 170 nm to 400 nm, such as in the range of 170 nm to 220 nm. Ionizing radiation includes high-energy radiation capable of generating ions and includes electron beam (e-beam) radiation, gamma radiation, and x-ray radiation. In a particular example, e-beam ionizing radiation includes an electron beam generated by a Van de Graaff generator, an electron-accelerator, or an x-ray. In an alternative embodiment, an elastomer may be crosslinkable through thermal methods. In a further example, an elastomer may be crosslinkable through chemical reaction, such as a reaction between a silane crosslinking agent and water. The nature and curing method may be influenced by the presence of cross-linking agents, catalysts, and initiators.

In an exemplary embodiment, the elastomeric material is a silicone formulation. The silicone formulation may be formed, for example, using a non-polar silicone polymer. In an example, the silicone polymer may include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In general, the silicone polymer is non-polar and is free of halide functional groups, such as chlorine and fluorine, and of phenyl functional groups. Alternatively, the silicone polymer may include halide functional groups or phenyl functional groups. For example, the silicone polymer may include fluorosilicone or phenylsilicone. In a particular example, the silicone polymer may include fluorosilicone.

In an embodiment, the silicone polymer is a platinum catalyzed silicone formulation. Alternatively, the silicone polymer may be a peroxide catalyzed silicone formulation. The silicone polymer may be a liquid silicone rubber (LSR) or a high consistency gum rubber (HCR). In a particular embodiment, the silicone polymer is a platinum catalyzed LSR. In a further embodiment, the silicone polymer is an LSR formed from a two part reactive system. Particular embodiments of LSR include Wacker 3003 by Wacker Silicone of Adrian, Mich. and Rhodia 4360 by Rhodia Silicones of Ventura, Calif. In another example, the silicone polymer is an HCR, such as GE 94506 HCR available from GE Plastics.

In an embodiment, self-bonding silicone polymers may be used. Self-bonding silicone polymers typically have improved adhesion to substrates compared to conventional silicones. Particular embodiments of self-bonding silicone polymers include GE LIMS 8040 available from GE Plastics and KE2090-40 available from Shin-Etsu. In a self-bonding silicone, a modification to the siloxane network, either through grafting chemically active functionalities onto the polysiloxane chains or incorporation of a separated chemical component into the matrix of the silicone rubber, generally reacts with the surface functions on a given substrate during the vulcanization process, which leads to better bonding property between the silicone rubber and this particular substrate in a multi-layer article.

In a particular embodiment, the second layer including the elastomer has a Shore A durometer in a range of 20 to 80, such as a range of 40 to 75, or even a range of 40 to 50. When the second layer includes a silicone formulation, the Shore A durometer (Shore A) of the silicone polymer cover may be less than about 75, such as about 20 to about 50, about 30 to about 50, or about 40 to about 50.

In another example, the material of the second layer has an elongation-at-break of at least 200%, such as at least 300%, at least 350%, or even at least 500%. The material may have an elongation-at-break of not greater than 1000%.

In a further example, the material of the second layer may have a tensile strength in a range of 100 pounds per square inch (psi) to 3000 psi, such as a range of 150 psi to 2000 psi, or even a range of 500 psi to 1000 psi as measured in accordance with ASTM D412. In an additional example, the material of the second layer may have a tensile modulus at 100% in a range of 10 psi to 1000 psi, such as a range of 35 psi to 500 psi, or even a range of 50 psi to 350 psi.

In an exemplary embodiment, the elastomer may further include a crosslinking agent, a photoinitiator, a filler, a plasticizer, or any combination thereof. Alternatively, the elastomer may be free of crosslinking agents, photoinitiators, fillers, or plasticizers. In particular, the elastomer may be free of photoinitiators or crosslinking agents.

To facilitate crosslinking, the elastomer may include a photoinitiator or a sensibilizer composition. For example, when ultra-violet radiation is contemplated as the form of irradiation or when e-beam radiation is contemplated as the form of irradiation, the material may include a photoinitiator to increase the crosslinking efficiency, i.e., degree of crosslinking per unit dose of radiation.

Crosslinking of the elastomer may also be facilitated by a chemical crosslinking agent, such as a peroxide, an amine, a silane, a sulfur, or any combination thereof. In an exemplary embodiment, the blend may be prepared by dry blending solid state forms of polymer and the crosslinking agent, i.e., in powder form. Alternatively, the material may be prepared in liquid form, sorbed in inert powdered support or by preparing coated pellets, or the like. The cross-linking agent may be thermally activatable.

Returning to FIG. 1, the second layer 104 may have a greater thickness than the first layer 102. For example, the total thickness of the layers of the construction 100 may be at least 3 mils to about 1000 mils, such as about 3 mils to about 500 mils, or even about 3 mils to about 100 mils. In an embodiment, the first layer 102 has a thickness in a range of about 0.1 mil to about 100 mil, such as a range of about 0.5 mil to about 100 mil, a range of about 1 mil to about 100 mil, a range of about 1 mil to about 50 mil, a range of about 1 mil to about 10 mil, or even a range of about 1 mil to about 2 mil. The second layer 104 and optionally other layers may make up the difference. In an example, the second layer 104 may have a thickness in a range of 0.1 mils to 100 mils, such as a range of about 1 mil to about 100 mil, a range of about 2 mil to about 50 mils, or even a range of about 5 mil to about 50 mil. In an alternative example, the second layer may have a thickness in a range of about 0.3 mil to about 1.5 mil, such as a range of about 0.3 mil to about 1.0 mil. In a further example, the ratio of the thickness of the second layer 104 relative to the thickness of the first layer 102 is at least 1.0, such as at least 1.5, at least 2.0, at least 5.0, or even at least 10.0.

While only two layers are illustrated in FIG. 1, the construction may further include additional layers (not illustrated). For example, additional elastomeric layers may be disposed on surface 110 of the second layer 104. Alternatively, additional layers, such as reinforcement layers may be incorporated within or between additional layers disposed in proximity to surface 110 of the second layer 104. An exemplary reinforcement layer may include a wire, a fiber, a fabric, such as a woven fabric, or any combination thereof, formed of a material such as polyester, an adhesion modified polyester, a polyamide, a polyaramid, a glass, a metal, or a combination thereof.

In a particular embodiment, the surface 110 may contact a hard material, such as a metal, ceramic, hard polymer, or combination thereof. For example, a treated fluoropolymer layer, such as a treated PTFE layer, may bond to a thermoplastic fluoropolymer, such as ETFE, which may be melt bonded to a metal or ceramic substrate. In another example, a treated fluoropolymer layer may bond to a thermoplastic elastomer, such as an acrylate, acetate, or thermoplastic polyurethane, which in turn may be bonded to a substrate, such as a metal, ceramic, hard polymer, or combination thereof.

While FIG. 1 includes an illustration of a generally planar polymeric article, the polymeric article may alternatively take the form of a film, a washer, or a fluid conduit. For example, the polymeric article may take the form or a film, such as a laminate, or a planar article, such as a septa or a washer. In another example, the polymeric article may take the form of a fluid conduit, such as tubing, a pipe, a hose or more specifically flexible tubing, transfer tubing, pump tubing, chemical resistant tubing, high purity tubing, smooth bore tubing, fluoropolymer lined pipe, or rigid pipe, or any combination thereof. As illustrated in FIG. 2, a fluid conduit 200 includes an inner liner 204 and an outer layer 202 overlying and directly contacting the inner liner 204. In particular, the inner liner 204 may form an interior surface 212 that has a low surface energy. In addition, the inner liner 204 may include a treated bond surface 208 that has been treated with a directed energizing treatment. The surface 208 is bonded directly to the outer layer 202, which may be formed of an elastomer, such as those described above. In a particular example, the inner liner 204 is formed of a fluoropolymer.

In a further example, FIG. 3 includes an illustration of a fluid conduit 300 that includes more than two layers. For example, an inner layer 304 may directly contact an intermediate layer 306 that is formed of an elastomer. An outer layer 302 may surround the intermediate 306. In a particular example, the inner layer 304 forms an inner surface 312 of the fluid conduit, which has a low surface energy. The intermediate layer 306 may be directly bonded to the inner layer 304. In particular, the intermediate layer 306 is bonded directly to the inner layer 304 without intervening layers, such as without an adhesive layer. For example, the intermediate layer 306 is a thermoplastic layer or an elastomer layer, which directly contacts the inner layer 304 without intervening adhesive layers or bond enhancing layers. At a surface 310 of the intermediate layer 306, an outer layer 302 may be bonded to surround the intermediate layer 306.

While the thicknesses of layers generally described in relation to FIG. 1 apply, the total thickness of the fluid conduit 300 may be between 3 mils and 1000 mils, such as 3 mils to 500 mils, or even 3 mils to 100 mils. The inner liner 302 may have a thickness in a range of 0.5 mils to 50 mils, such as 0.5 mils to 20 mils, 1 mil to 10 mils, or even 1 mil to 2 mils, the intermediate and outer layers making up the difference.

In a particular embodiment, the polymeric article, such as a fluid conduit is formed by dispensing a first polymer layer comprising a fluoropolymer or other low surface energy polymer and applying a second polymer layer to directly contact the bond surface of the first polymer layer, such as without intervening adhesive or bond enhancing layers. In an example, the bond surface of the first polymer layer is prepared with a directed energizing treatment. The second polymer layer includes an elastomer or a thermoplastic polymer.

In an embodiment, the directed energizing treatment includes preparing the bond surface of a polymer layer with an ion beam derived from a non-reactive gas, such as a noble gas. For example, the noble gas may include argon, neon, helium, krypton, or any combination thereof. In particular, the non-reactive gas is free of a reactive gas, such as nitrogen, oxygen, hydrogen, ammonia, formic acid, acetic acid, ethanol, acetylene, ethylene or any combination thereof. In particular, the non-reactive ion beam treatment is performed under a vacuum in a range of 0.1 mTorr to 100 mTorr, such as a range of 0.5 mTorr to 10 mTorr, or even 0.5 mTorr to 5 mTorr. In addition, the non-reactive ion beam treatment is performed using an ion energy in a range of 330 eV to 50 keV, such as a range of 400 eV to 10 keV, a range of 667 eV to 5000 eV, or even a range of 1330 eV to 2000 eV, such as approximately 1667 eV, and an ion dose in a range of 20 mC/cm² to 150 mC/cm², such as a range of 60 mC/cm² to 97 mC/cm², a range of 70 mC/cm² to 97 mC/cm², or even a range of 80 mC/cm² to 88 mC/cm², for a period in a range of 5 seconds to 15 minutes, such as a range of 5 seconds to 10 minutes, a range of 5 seconds to 1 minute, a range of 5 seconds to 30 seconds, or even approximately 20 seconds. The resulting surface may have a low surface energy and a high water contact angle, and may have a low concentration of surface species that include oxygen or nitrogen. Yet, the surface provides for a strong bond between the fluoropolymer layer and the elastomer or thermoplastic layer.

In addition to treating the fluoropolymer or low surface energy polymer layer, the method may further include extruding the elastomer or thermoplastic over the fluoropolymer or other low surface energy polymer layer and optionally curing the elastomer. For example, applying the second layer over the first layer may include extruding the elastomer or thermoplastic to directly contact the bond surface of the fluoropolymer layer. In another example, the elastomer or thermoplastic may be injection molded over the treated low surface energy polymer layer. In a further example, the low surface energy polymer layer may be formed over a mandrel, treated on the mandrel, and the elastomer or thermoplastic layer extruded over the low surface energy polymer layer on the mandrel. In an additional example, the elastomer or thermoplastic may be extruded over a treated film layer or may be laminated to the treated film layer. In addition, the elastomer may be a curable elastomer and thus, may be cured in place using a variety of chemical or irradiating techniques.

In an exemplary embodiment, the elastomer may be cured through cross-linking, depending on the nature and additives associated with the elastomer. In an example, the elastomer may be cross-linkable through thermal treatment or through radiation, such as using x-ray radiation, gamma radiation, ultraviolet electromagnetic radiation, visible light radiation, electron beam (e-beam) radiation, or any combination thereof. Ultraviolet (UV) radiation may include radiation at a wavelength or a plurality of wavelengths in the range of from 170 nm to 400 nm, such as in the range of 170 nm to 220 nm. Ionizing radiation includes high-energy radiation capable of generating ions and includes electron beam (e-beam) radiation, gamma radiation, and x-ray radiation. In a particular example, e-beam ionizing radiation includes an electron beam generated by a Van de Graaff generator, an electron-accelerator, or an x-ray. In an alternative embodiment, the diene elastomer may be crosslinkable through thermal methods. In a further example, the diene elastomer may be crosslinkable through chemical reaction, such as a reaction between a silane crosslinking agent and water.

The resulting polymeric article has a high peel strength, while exhibiting a low surface energy, a high water contact angle, and few surface species that include oxygen or nitrogen. For example, the polymeric article, such as a fluid conduit may have desirable peel strength. Peel strength may be measured after formation of the hose but prior to a post cure treatment or may be measured after a post-cured treatment, such as after a thermal treatment or further irradiation treatment.

In general, the peel strength of the polymeric article is at least 2.5 ppi, such as at least 5 ppi, at least 7 ppi, or even at least 10 pound per inch (ppi). For example, the peel strength may be at least 14 ppi, such as at least 16 ppi, at least 20 ppi, or even at least 22 ppi. In particular examples, the peel strength is at least 25 ppi, such as at least 28 ppi, at least 30 ppi, or even at least 50 ppi. In addition, the polymeric article maintains peel strength and, in particular examples, exhibits an increased peel strength after a post cured treatment, such as after a post cured thermal treatment or irradiation treatment. In an example, the post cure peel strength is at least 7 ppi, such as at least 10 ppi, at least 14 ppi, at least 16 ppi, at least 20 ppi, at least 25 ppi, or even at least 50 ppi. While particular thermoplastic polymers exhibit poor bonding and very low peel strength when formed over untreated surfaces, such as thermoplastic polymers surprisingly bond to the low surface energy polymer layer that is treated with a directed energizing treatment. Such thermoplastic polymers exhibit a peel strength of at least 2.5 ppi, such as at least 5 ppi. Cohesive failure during peel strength testing indicates that the peel strength of the bond is greater than the measured peel strength at the point of cohesive failure.

Further, the polymeric article may exhibit a high peel strength after exposure to UV radiation. For example, the polymeric article may exhibit a Durability Index, defined as the percent decrease in peel strength after exposure to UV radiation as in Example 9, of not greater than 50%, such as not greater than 30%, not greater than 25%, or even not greater than 20%.

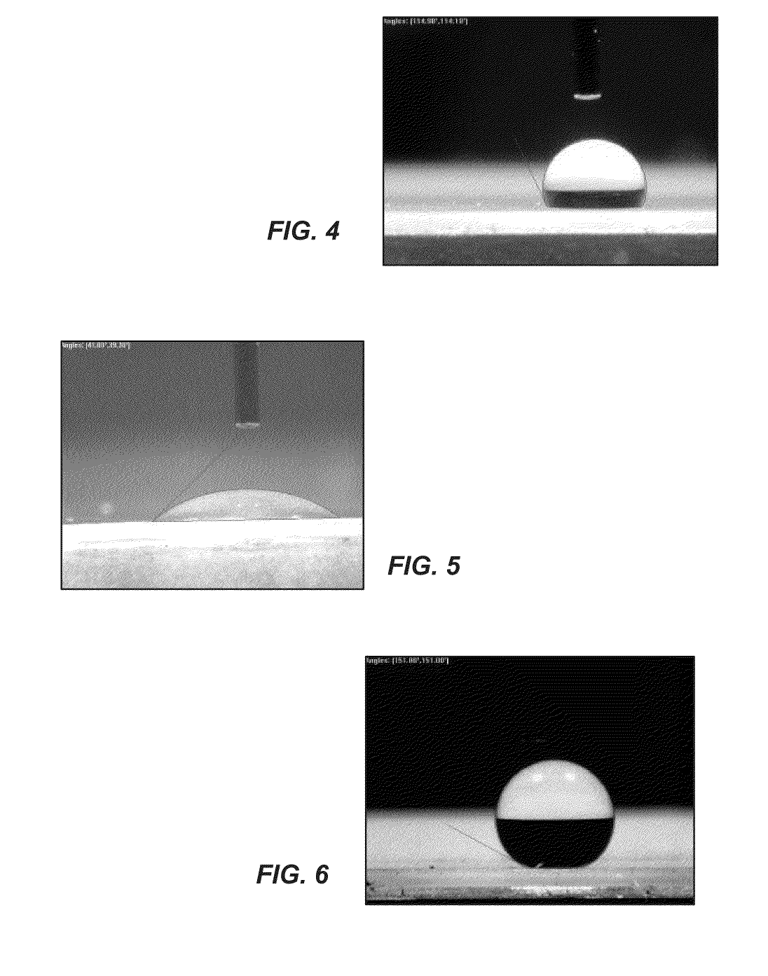

In addition, the low surface energy polymer layer of the polymeric article may exhibit a desirably high water contact angle, greater than the water contact angle of the untreated low surface energy polymer. For example, FIG. 4 includes an illustration of a water droplet on an untreated skived PTFE sheet. As illustrated, the water contact angle is typically 115°. The contact angle is the angle formed between the horizontal surface and a line tangential to the surface of the water droplet at the contact point of a water droplet and the horizontal surface. Typically, the contact angle is measured between the horizontal surface and the tangential line through the droplet. Generally, chemical etch treatment methods reduce the water contact angle, indicating a higher surface energy. FIG. 5 includes an illustration of a skived PTFE treated with a sodium ammonia etch. The water contact angle is approximately 40°. In contrast, a PTFE surface treated with a non-reactive ion beam treatment exhibits a water contact angle greater than 115°, as illustrated in FIG. 6. In a further example, a PTFE surface treated with a UV laser treatment exhibits a water contact angle of greater than 115°, such as at least 145°, as illustrated in FIG. 18. In particular, the water contact angle of the treated low surface energy polymer layer may be at least 120°, such as at least 125°, at least 130°, at least 140°, or even 150° or higher. In an example, the treatment increases the water contact angle of the low surface energy polymer layer by at least 5°, such as at least at least 10°, at least 15°, at least 20°, or even at least 25°. Further, a contact index is defined as the change in water static contact angle relative to an untreated surface. As such, the low surface energy polymer layer may have a contact index of at least 5%, such as at least 10%, at least 15%, at least 20%, or even at least 25%. The high water contact angle indicates hydrophobicity.

The hydrophobicity may be caused by the absence of hydrophilic species on the surface, by the surface roughness, or a combination thereof. For example, the treated surface may include a low concentration of species and byproducts that include oxygen or nitrogen. In an example, the surface may be substantially free of oxygenated species. In particular, as measured by x-ray photoelectron spectroscopy (XPS), the surface of the fluoropolymer layer may have not greater than 5% (atomic conc.) oxygen species, such as not greater than 3.4%, not greater than 2% or even not greater than 1.5% oxygen species. In addition, the surface of the fluoropolymer layer may be free of species that incorporate nitrogen. For example, the surface of the fluoropolymer layer may have a nitrogen species content of not greater than 2% (atomic conc.), such as not greater than 1.5%, or even not greater than 1%.

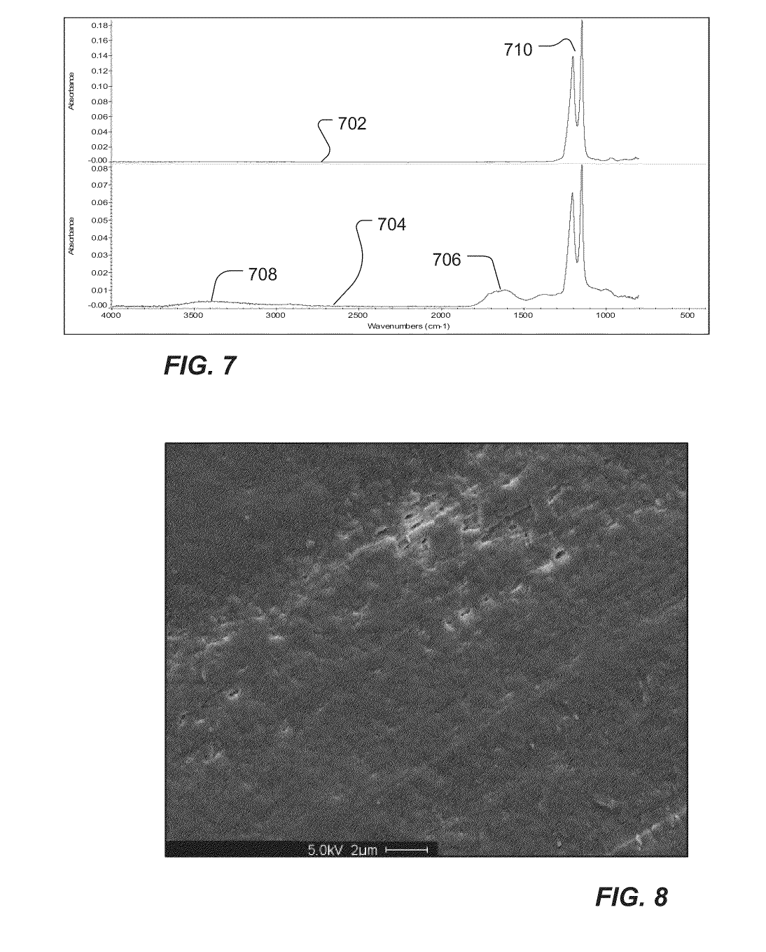

Such lack of surface species is further illustrated by FIG. 7, which includes an illustration of a Fourier transform infrared spectroscopy (FTIR) of a chemical etch treated PTFE sample and a non-reactive ion beam sample. Line 702 represents the FTIR spectrum of a non-reactive ion beam treated sample and line 704 illustrates the FTIR spectrum of a sodium ammonia etched surface. While both graphs illustrate peaks 710 indicative of C—F bonds, only the sodium ammonia etched sample exhibits peaks 706 indicative of C═O stretching and conjugated C═C stretching. In addition, the sodium ammonia etched FTIR spectrum 704 includes a peak 708 indicative of —OH hydrogen stretching. In contrast to the FTIR spectrum 704 of the sodium ammonia etched sample, the FTIR spectrum 702 is remarkably devoid of peaks associated with OH groups, C═O groups, or alkenyl groups.

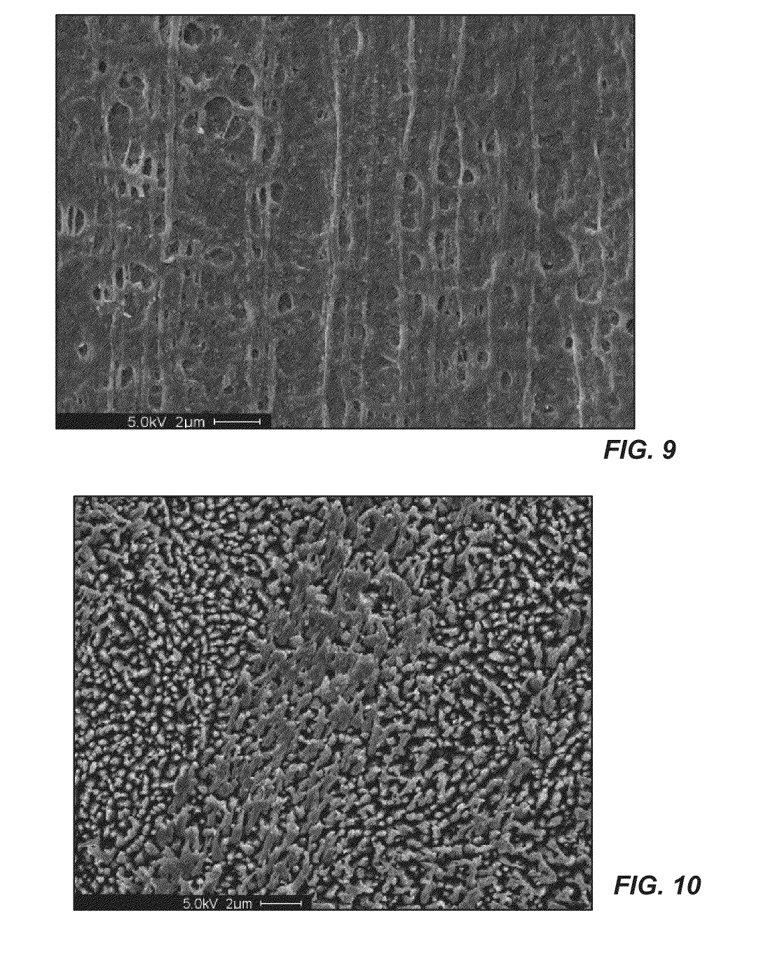

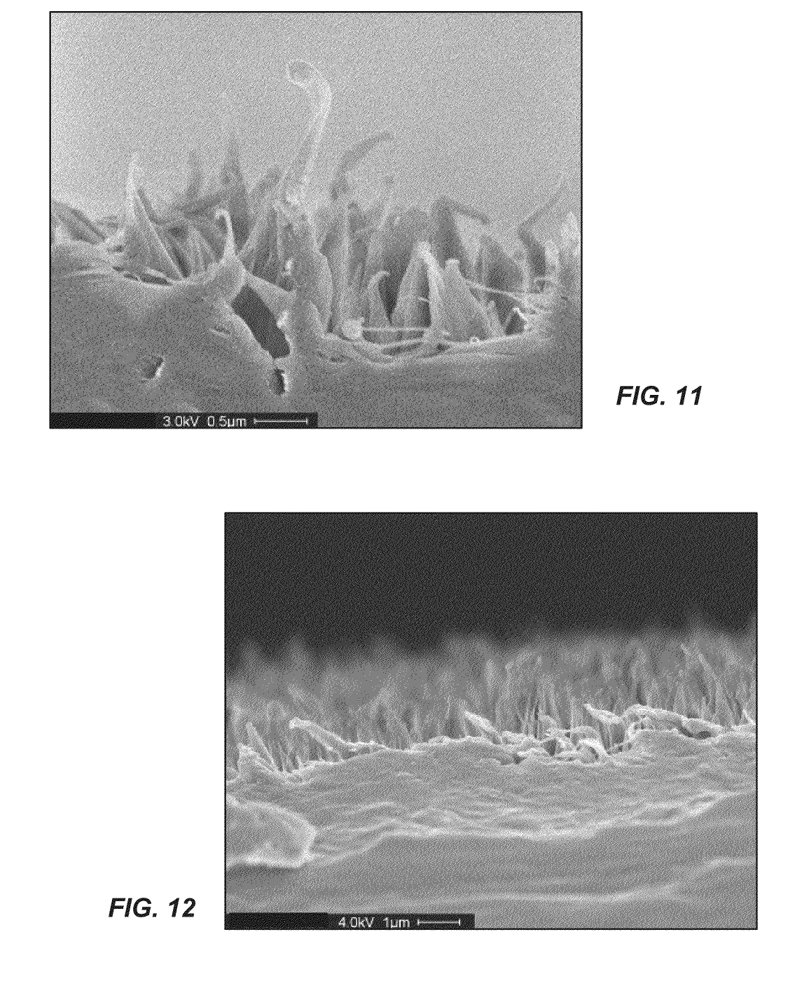

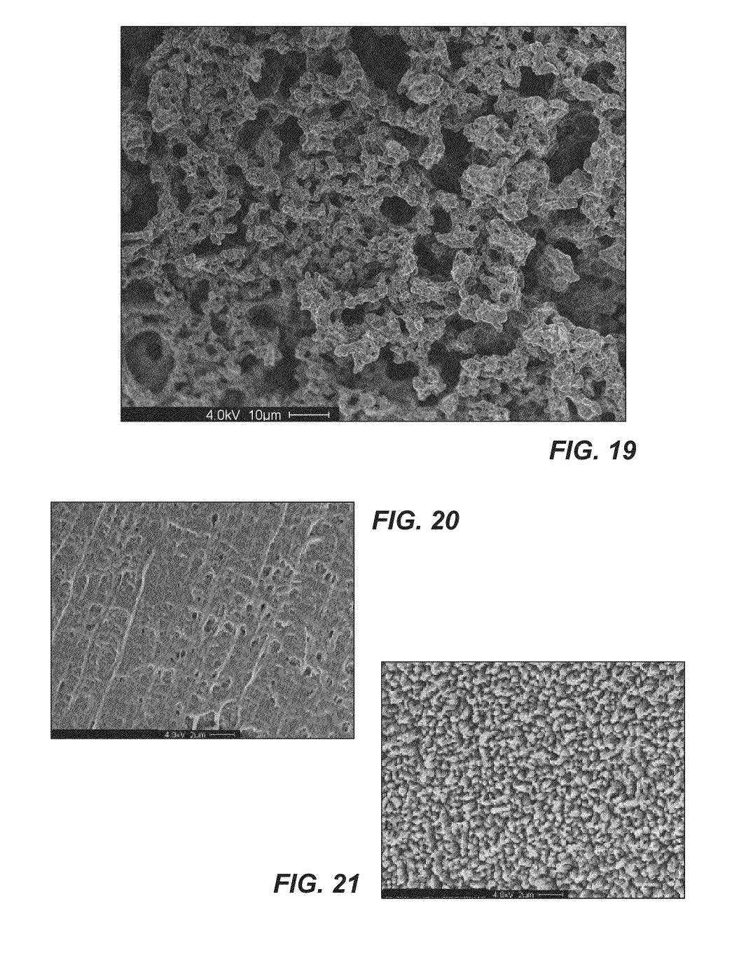

In addition, a surface treated with a directed energizing treatment has a desirable morphology having surface features that encourage mechanical bonding. In an example, the ion beam treated surface exhibits a unique surface morphology relative to untreated fluoropolymer surfaces and the chemically etched fluoropolymer surfaces. As illustrated in FIG. 8, a skived PTFE surface that is untreated exhibits relatively smooth unmarked surfaces with only periodic blemishes. As illustrated in FIG. 9, chemically etched PTFE, such as skived PTFE that is etched with a sodium ammonia etch, exhibits a pockmarked morphology. In contrast, FIG. 10, FIG. 11, and FIG. 12 include illustrations of an exemplary ion beam etched skived PTFE surfaces. The ion beam treated surface exhibits a tufted morphology in which a plurality of relatively tall filament-like structures extend from the base of the fluoropolymer material. In particular, the filament-like structures may have a length in a range of 100 nm to 10.0 μm, such as a range of 100 nm to 3.0 μm. In another example, a UV laser treated surface, as illustrated in FIG. 19, has a sponge-like structure.

In an embodiment, the treated surface may have a roughness (Rz) of at least 4 μm, such as at least 6 μm, or even at least 8 μm. Roughness (Rz) is the mean of distance between the 5 highest peaks and the 5 deepest holes. A neighborhood of 3×3 is taken into account to find the peaks and the valleys. In particular examples, the roughness (Rz) may be at least 10 μm, such as at least 20 μm, or even at least 50 μm. In particular, the treated surface may have a morphology that has a roughness index of at least 2 relative to the initial material surface. The roughness index is the ratio of roughness (Rz) of the treated surface to the roughness (Rz) of the untreated surface. In an example, the treated surface exhibits a roughness index of at least 3, such as at least 4, at least 10, or even at least 20. In another example, the treated surface may have a roughness (PV) of at least 4 μm, such as at least 6 μm, or even at least 8 μm. Roughness (PV) is the distance between the lowest and the highest point on the test surface. In a particular example, the roughness (PV) may be at least 10 μm, such as at least 20 μm, or even at least 50 μm. In a further example, the roughness (Ra) is at least 0.3 μm, such as at least 0.4 μm. For example, the roughness (Ra) may be at least 1 μm, such as at least 2 μm, or even at least 4 μm. Roughness (Ra) is the arithmetic mean deviation of the surface. Roughness may be determined using a Zygo® NewView 6200/6300 White Light Interferometer.

It has surprisingly been found that the polymer articles described above and formed through the methods described above exhibit technical advantages not previously recognized in prior art constructions. Particular embodiments of polymeric articles formed in accordance with the above description exhibit high peel strength without intervening adhesive layers or bond enhancing layers. In particular, some embodiments exhibit high peel strength while having high water contact angles or low measures of additional species on the surface of the PTFE. In addition, the substantial absence of byproduct surface species found in some embodiments provides for low contamination of fluids traversing a fluid conduit, for example. In particular, such surface species formed through chemically reactive processes may leach from a hose into fluid traversing a fluid conduit, contaminating the fluid. For example, partially oxygenated and fluorinated species may pose a health risk to individuals in the event that such a hose were used in an industry, such as for food processing or pharmaceutical production.

Such polymeric articles and methods are contrasted with the prior art teachings that encourage chemical treatment of surfaces that may lead to the formation of dangerous surface species or reduce the water contact angle of the low surface energy polymer. In contrast, embodiments of the present invention include surfaces that have high water contact angles and few hydrophilic surface species, while exhibiting desirable bonding, such as demonstrated by high peel strength without adhesives, such as adhesive epoxy, cyanurate, cyanoacrylates, or adhesive polyurethane.

### EXAMPLES

### Example 1

Samples are prepared of skived PTFE treated with a non-reactive ion beam surface source. A control sample remains untreated and a comparative sample is treated with sodium in liquid ammonia (Na—NH₃) etch.

The surface treatment of the skived PTFE samples includes exposing the surface of the PTFE sample to an argon ion beam under a vacuum of 0.5 mTorr to 50 mTorr, at a ion energy in a range of 330 eV to 5000 eV and a ion dosage in a range of 20 mC/cm² to 150 mC/cm² for a period of in a range of 5 seconds to 30 seconds.

The comparative sample is prepared using a conventional Na—NH₃ etch procedure. The etch solution includes 40 grams of sodium per gallon of liquid ammonia.

The samples, the control sample, and the comparative sample are analyzed using x-ray photoelectron spectroscopy (XPS) to determine the atomic concentration of surface species. Table 1 presents the range of atomic concentrations for the samples, in addition to concentrations for the control and comparative samples.

TABLE 1
Atomic Concentration of Surface Species.

| | | | Na—NH₃ treated |
|---|---|---|---|
| | Untreated PTFE | Ar Ion Beam- | PTFE |
| | (control) | treated PTFE | (comparative) |
| C | 37.3% | 40-42% | >80% |
| F | 61.9% | 55-60% | <10% |
| O | 0.8% | 1-2% | 10-15% |
| N | | ~1% | ~1% |
| Na | | | <1% |

As illustrated in Table 1, the ion beam-treated samples have a slightly greater carbon concentration and a slightly smaller fluorine concentration than the untreated control sample. In addition, the oxygen concentration is slightly greater than that of the untreated control sample. In contrast, the comparative sample exhibits a significantly greater carbon concentration, low fluorine concentration, and high oxygen concentration.

A sample and the comparative sample are also tested using Fourier transform infrared (FTIR) spectroscopy. As illustrated in FIG. 7, both the sample and the comparative sample exhibit strong peaks 710, indicative of C—F bonds. However, the comparative sample spectrum 704 includes peaks 706 at approximately 1750 cm⁻¹ and 1500 cm⁻¹, indicative of C═O and C═C bonds, and includes a peak 708 at approximately 2900 cm⁻¹, indicative of —OH stretching. In contrast, the tested sample spectrum 702 does not indicate the presence of such bonds.

A sample, the control sample, and a comparative sample are tested for contact angle. A deinonized water droplet is deposited on the surface of the sample, the control sample, and the comparative sample. The contact angle is the angle defined between horizontal surface on which the water droplet is disposed and a line extending tangentially along the surface of the droplet at the point at which the droplet contacts the surface as measured through the droplet. Water contact angle measurements were performed using a VCA 2500XE Video Contact Angle System from AST, Inc. The method described above and used to measure all contact angles presented in this work is called the static sessile drop method using deionized water. As illustrated at FIG. 4, the control sample exhibits a water contact angle of 115°. As illustrated in FIG. 5, the comparative sample has a water contact angle of 40° and, as illustrated in FIG. 6, the ion beam-treated sample has a water contact angle of 150°. Table 2 summarizes the water contact angles.

TABLE 2
Water Contact Angle for Treated Samples

| | Water Contact |
|---|---|
| | Angle (degrees) |
| Control Sample | 115 |
| Na—NH₃ etch Comparative Sample | 40 |
| Ion Beam-treated Sample | 150 |

A sample, the control sample, and the comparative sample are tested using scanning electron microscopy (SEM). As illustrated in FIG. 8, the control sample is generally smooth, exhibiting only a few blemishes. The Na—NH₃ etched comparative sample illustrated in FIG. 9 exhibits a pockmarked surface. In contrast, the ion-beam treated sample exhibits a tufted morphology, including a plurality of filament-like surface structures, as illustrated in FIG. 10.

### Example 2

Samples are prepared using treated skived PTFE and self-bonding Santoprene™ 8291-65TB. The skived PTFE is prepared using one of non-reactive ion beam treatment, Chemlock treatment, Na—Naphthalene treatment, or Na—NH₃ treatment. One sample is untreated. The samples are tested for peel strength using an adhesion test.

The samples are prepared by an insert molding method. A Santoprene™ slab is placed onto the treated PTFE layer and compression molded at 150° C. for 3 minutes in a 2 mm slab mold. A second set of samples are prepared as above and further post cured using a thermal treatment at 135° C. for 75 minutes after molding.

One (1) inch×5 inch test pieces are cut from the resulting sample. A 180° peel test is conducted to evaluate the bonding strength between the Santoprene™ and the treated PTFE, following the procedure of ASTM D-413. The test is performed on an Instron 4465 machine. The layers of the sample are clamped into the two Instron grips. The top grip transverses in the vertical direction at a rate of 2 inches per minute, which pulls the Santoprene™ 180° away from the treated PTFE substrate. Table 3 illustrates the peel strength.

TABLE 3
Peel Strength of Treated Samples

| | Non-Post Cure Peel | Post Cure Peel |
|---|---|---|
| Substrate | Strength (ppi) | Strength (ppi) |
| Ion beam-treated Sample #1 | 20.3 | 20.3 |
| Ion beam-treated Sample #2 | 19.3 | 20.9 |
| Chemlock treated | 3.7 | 6.3 |
| Na-Napht treated | 5.5 | 10.7 |
| Na—NH₃ treated | 22.7 (CF) | 20.9 (CF) |
| Non-treated | 0.1 | 0.1 |

CF—cohesive failure

The two ion beam-treated samples exhibit peel strength of approximately 20 ppi, which is comparable to the peel strength of the Na—NH₃ treated sample and significantly greater than the other samples.

### Example 3

Samples are prepared using substrates selected from ion beam-treated PTFE or Na—NH₃ treated PTFE. The substrate is molded to an elastomer selected from C-Flex® 082, EPDM (Nordel™ IP 3702P), or thermoplastic polyurethane (TPU, Estane® 580-70). The samples are tested for peel strength in accordance with the procedure outline above in Example 2. Table 4 illustrates the peel strength of the samples.

TABLE 4
Peel Strength for Various Elastomers

| | Peel Strength (ppi) | | |
|---|---|---|---|
| Substrate | C-Flex ® | EPDM | TPU |
| Ion Beam Treated | 20.9 | 30.4 | 26.7 |
| Na—NH₃ Treated | 2.0 | 22.0 | 29.4 |

As illustrated in Table 4, the sample including ion beam treated substrate and a TPU elastomer exhibits similar peel strength to the sample including the Na—NH₃ treated substrate and TPU. However, the samples including ion beam treated substrates exhibit significantly greater peel strengths when bonded to C-Flex® or Nordel™ EPDM than similar samples with Na—NH₃ treated substrates.

### Example 4

Samples are prepared using an ion beam treated PTFE substrate and a silicone elastomer selected from self-bonding LSR (Elastosil® LR 3003/50) or self-bonding HCR (Sanitech 50). The samples are post cured as described in relation to Example 2. Peel strength is tested using the procedure described above in relation to Example 2. As illustrated in Table 5, the peel strength of the samples is at least 20 ppi and even as high as 28.0 ppi or higher.

TABLE 5
Peel Strength with Self-bonding Silicone Elastomer

Peel Strength (ppi)

| | Sample #1 | Sample #2 |
|---|---|---|
| SB LSR (PC) | 22.4 | 28.7 |
| SB HCR (PC) | 28.0 | 26.6 |

PC—post cured

### Example 5

Samples are prepared using an ion beam treated PTFE substrate and an elastomer selected from non-self-bonding LSR, non-self-bonding HCR, self-bonding HCRs (Sanitech 50), non-self-bonding Santoprene™ 65MED, self-bonding Santoprene™ 8261-65TB, C-Flex® R70-082, Nordel™ EPDM, Estane® 580-70 TPU, polypropylene, high density polyethylene (HDPE), polycarbonate, or KynarFlex®. A set of samples are post cured as described in relation to Example 2. Peel strength is tested using the procedure described above in relation to Example 2. Table 6 illustrates the peel strength of the samples.

TABLE 6
Peel Strength on Various Polymers

Peel Strength (ppi)

| | Not Post Cured | Post Cured |
|---|---|---|
| NSB LSR | 22.7 (CF) | 32.04 |
| NSB HCR | 14.9 | 28.1 (CF) |
| SB HCR 1 | 22.0 | 24.1 |
| SB HCR 2 | 25.6 | 29.6 (CF) |
| NSB Santoprene ™ | 1.35 | |
| SB Santoprene ™ | 20.3 | 20.3 |
| C-Flex 082 | 20.9 (CF) | |
| EPDM | 30.4 | |
| TPU | 26.7 | |
| Polypropylene | 7.9 | |
| HDPE | 5.6 | |
| Polycarbonate | 4.0 | |
| KynarFlex ® | 2.9 | |

CF—cohesive failure
SB—self-bonding
NSB—non-self-bonding

As illustrated, the non-reactive ion beam treated substrates exhibit strong peel strength when bonded to silicone elastomer (LSR or HCR) whether self-bonding or not. In regard to Santoprene™, the peel strength is greater for self-bonding Santoprene™. In addition, the non-reactive ion beam treated substrates exhibit strong peel strength when bonded to other elastomers, such as EPDM or TPU. For other polymer species, the peel strength is relatively weaker. In particular, the peel strength for thermoplastic species, such as polypropylene and polycarbonate, are lower, but such peel strength represents a bond strength not found in untreated samples. Generally, such thermoplastics fail to bond or delaminate easily from untreated samples. Even a thermoplastic fluoropolymer such as KynarFlex® that does not generally bond to PTFE surfaces, exhibits a coherent laminated structure when bonded to the treated PTFE layer.

### Example 6

Samples are prepared using a substrate selected from an ion beam treated PTFE substrate or a Na—NH₃ treated PTFE substrate. The samples include an over-molded elastomer selected from Nordel™EPDM or C-Flex®. After molding, the samples are peeled and the bond surfaces of the PTFE substrates are subjected to FTIR spectroscopy.

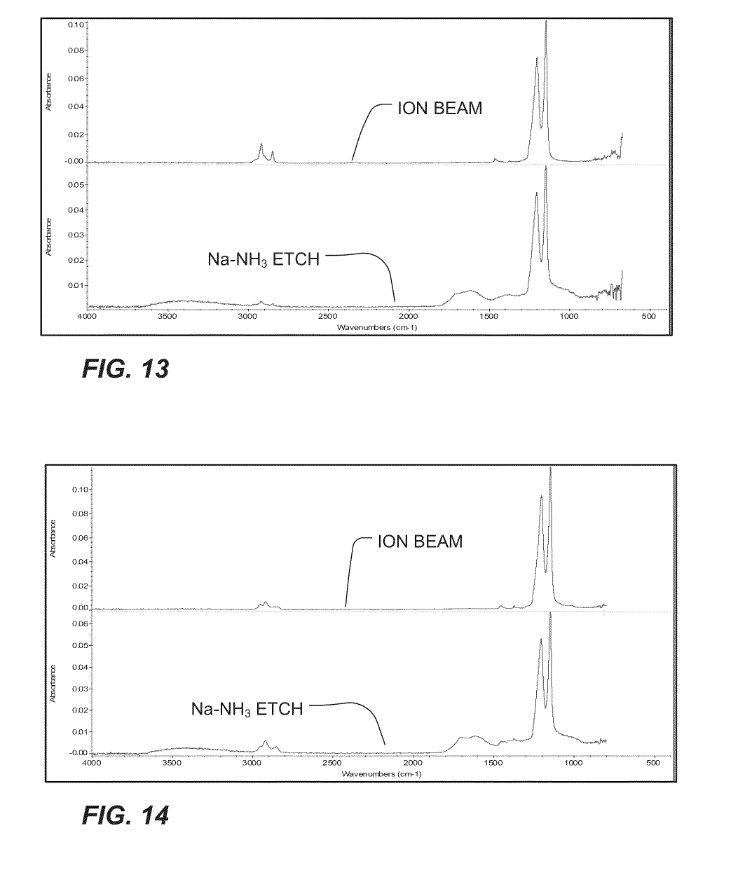

FIG. 13 illustrates the FTIR spectrum for substrates peeled from EPDM. The Na—NH₃ treated PTFE surface exhibits peaks at approximately 3400 cm⁻¹, indicating the presence of —OH bonds, and exhibits peaks around 1750 cm⁻¹ and 1500 cm⁻¹, indicating C═O and C═C bonds. In contrast, the ion beam-treated PTFE surface does not exhibit such peaks. Both surfaces exhibit peaks around 1210 cm⁻¹ and 1152 cm⁻¹, indicating C—F bonds. In addition, both surfaces exhibit peaks in the range of 2800 cm⁻¹ to 2900 cm⁻¹, indicative of C—H bonds, which may be indicative of residual EPDM.

FIG. 14 illustrates the FTIR spectrum for samples peeled from C-Flex®. As with the EPDM samples, the Na—NH₃ treated PTFE surface exhibits peaks at approximately 3400 cm⁻¹, indicating the presence of —OH bonds, and exhibits peaks around 1750 cm⁻¹ and 1500 cm⁻¹, indicating C═O and C═C bonds. In contrast, the ion beam-treated PTFE surface does not exhibit such peaks. Both surfaces exhibit peaks around 1210 cm⁻¹ and 1152 cm⁻¹, indicating C—F bonds. In addition, both surfaces exhibit peaks in the range of 2800 cm⁻¹ to 2900 cm⁻¹, indicative of C—H bonds, which may be the result of residual C-Flex®.

### Example 7

Surface roughness is measured for samples prepared in accordance with Example 1. The samples are measured using a Zygo® device. In addition, SEM images are taken of the samples. Table 7 illustrates the surface roughness for untreated, sodium-ammonia treated, non-reactive ion beam treated, and UV laser treated samples.

TABLE 7
Surface Roughness for Treated Samples

| Sample | Ra (μm) | Rz (μm) | Pv (μm) | Rᵣₘₛ (μm) |
|---|---|---|---|---|
| Untreated | 0.19 | 1.6 | 2.1 | 0.24 |
| Na—NH₃ | 0.28 | 2.2 | 3.0 | 0.36 |
| Ion Beam | 0.49 | 8.8 | 10.0 | 0.73 |
| UV Laser | 5.2 | 50.4 | 60.3 | 6.8 |

As illustrated, the surface roughness (Rz) is at least 8 μm for the ion-beam treated samples, whereas the surface roughness (Rz) is less than 2 μm for the sodium-ammonia treated and the untreated samples. For the UV treated sample, the surface roughness is at least 50 μm. In addition, as illustrated in FIG. 11 and FIG. 12, SEM images illustrated the tufted morphology of the surface of the non-reactive ion-beam treated samples. The morphology of the UV treated sample is illustrated in the SEM image of FIG. 19.

### Example 8

To test the nature of the bond between polymer layers and the treated fluoropolymer surface, an experiment is performed to dissolve or delaminate the polymer layer from the surface of the fluoropolymer layer without mechanical action. After dissolution or delamination, the surface of the fluoropolymer is scanned using FTIR to look for surface species. In another test, an attempt is made to re-bond to the surface using the a polymer layer similar to the dissolved or delaminated polymer layer.

In particular, the ion beam treated surface layer exhibits few surface species associated with the dissolved or delaminated polymer when tested with FTIR (See FIG. 15, location 1502 lacks a peak), indicating that the predominant component of bond strength is attributable to the mechanical nature of the bond. In contrast, the Na—NH₃ treated surface exhibits remnants of surface species of the dissolved or delaminated polymer (See FIG. 16, location 1602 includes a relatively large peak and location 1604, indicative of C═O/C═C species, includes a large peak), indicating a greater amount of chemical bonding. As illustrated by the SEM images of FIG. 20 (Na—NH₃) and FIG. 21 (Ion Beam), the surface maintain their respective morphologies

When an attempt is made to bond a polymer layer to the treated surface after dissolution or delamination of a first polymer layer, the ion beam treated surface exhibits a similar bond strength than the initial bond to the later dissolved or delaminated polymer layer. Accordingly, the bond strength of the ion beam treated surface is not degraded with solvent cleaning, even prior to a first bonding to a polymer layer.

### Example 9

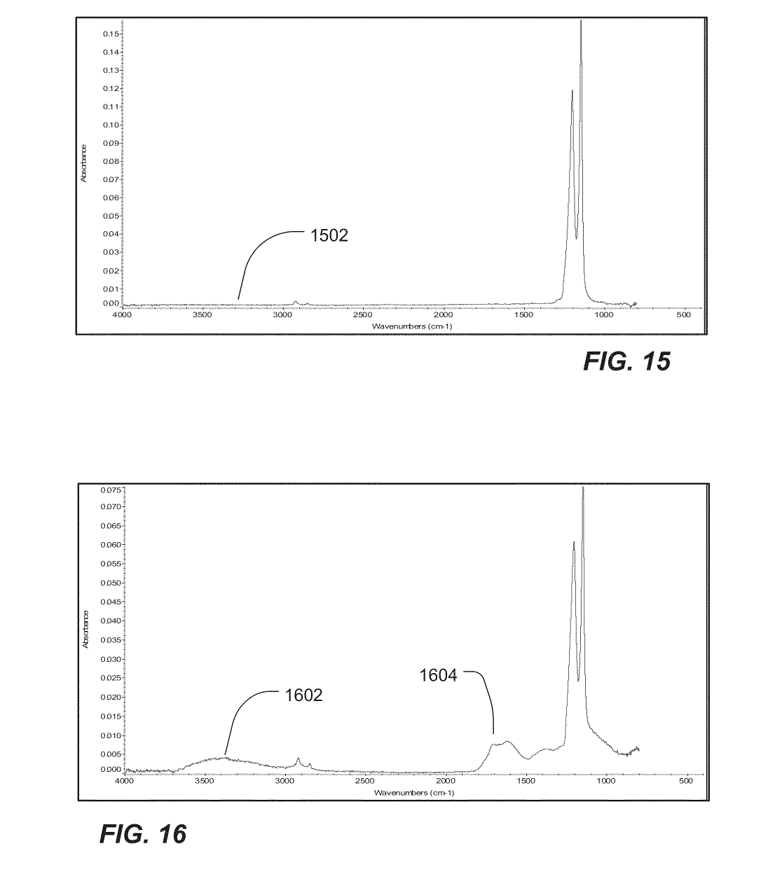

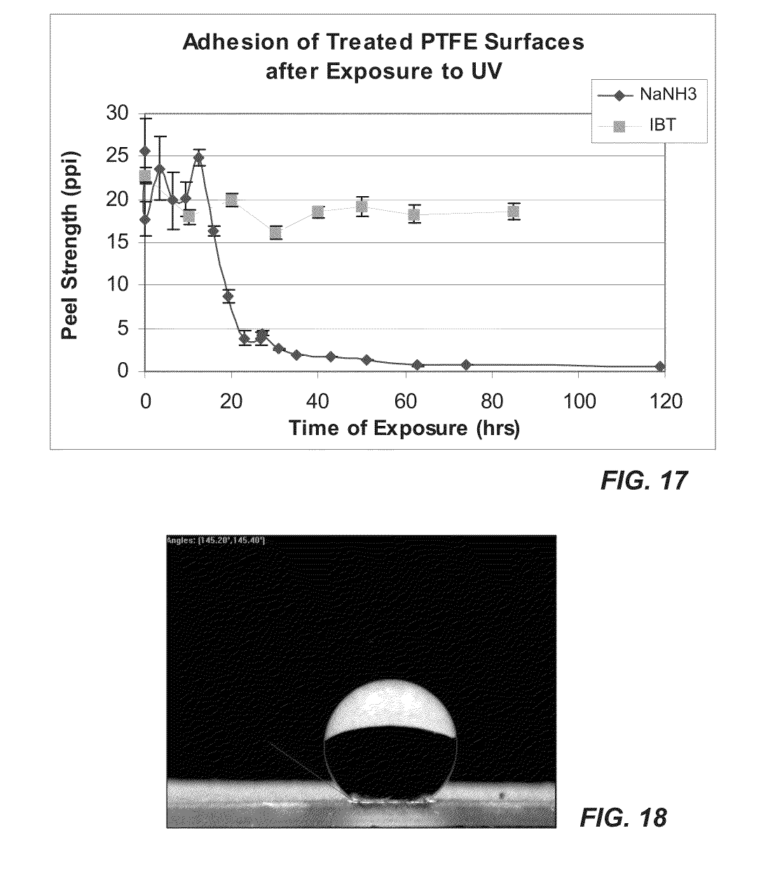

PTFE samples are exposed to UV radiation and tested for peel strength with elastomers. The surface of an ion beam treated sample and the surface of a Na—NH₃ treated sample are exposed to UV radiation for different periods of time using UVA radiation at a wavelength of 340 nm and an irradiance of 0.77 W/m²/nm at a temperature of 45° C. Once exposed, the samples are molded to a self-bonding HCR silicone and tested for peel strength. As illustrated in FIG. 17, with increasing exposure, the ion beam treated surfaces maintain peel strength, whereas the Na—NH₃ treated samples show a marked reduction in peel strength with increasing exposure to UV radiation.

Samples formed of treated PTFE layers bonded to an elastomer layer are exposed to UV radiation and tested for peel strength. Table 8 illustrates the initial peel strength and the peel strength after exposure to UV radiation for 54 hours. As illustrated, the samples formed of ion-beam treated PTFE bonded to self-bonding HCR silicone or to EPDM show a smaller decrease in peel strength than samples formed of Na—NH₃ treated PTFE bonded to self-bonding HCR silicone or to EPDM.

TABLE 8
Peel Strength for UV Exposed Samples

| | Initial Peel | 54 Hour Peel | Percent |
|---|---|---|---|
| | Strength (ppi) | Strength (ppi) | Change (%) |
| SB HCR/Na—NH₃ | 26.6 | 18.1 | −32 |
| SB HCR/Ion Beam | 29.6 | 24.7 | −16 |
| EPDM/Na—NH₃ | 28.1 | 6.0 | −78 |
| EPDM/Ion Beam | 23.6 | 14.1 | −40 |

### Example 10

Ion beam treatment of various polymer samples exhibit desirable bond strength to elastomers and thermoplastic polymers. Samples of skived PTFE, paste extruded PTFE, FEP, and PFA are treated with an ion beam treatment and bonded to a polymer selected from non-self-bonding (NSB) HCR silicone, self-bonding (SB) HCR silicone, self-bonding Santoprene™, C-Flex® 082, and Nordel™ EPDM. As illustrated in Table 9, the samples exhibit desirable peel strength.

TABLE 9
Peel Strength of Ion Beam Treated Samples

| | | Paste | | |
|---|---|---|---|---|
| | Skived | Extruded | | |
| | PTFE | PTFE | FEP | PFA |
| NSB HCR (PC) | 28.9 ppi | | | |
| SB HCR (PC) | 25.15 ppi | 17.95 ppi | 50.97 ppi | 49.64 ppi |
| SB Santoprene ™ (PC) | 20.74 ppi | 18.91 ppi | 22.54 ppi | 22.14 ppi |
| C-Flex ® | 20.91 ppi | | | |
| Nordel ™ EPDM | 30.38 ppi | | | |

PC—post cured

### Example 11

Ion beam treated PTFE samples are subjected to XPS testing to determine the atomic concentration of surface species. Table 10 illustrates a relatively low concentration of nitrogen and oxygen surface species.

TABLE 10
Concentration of Surface Species

| | Sample #1 | Sample #2 |
|---|---|---|
| % at. C | 35.1 | 39.9 |
| % at. N | 0.5 | 0.1 |
| % at. O | 3.3 | 2.1 |
| % at. F | 61.1 | 58.0 |

As illustrated by the above examples, non-reactive ion beam-treatment (i.e., ion beam treatment using non-reactive gasses) permits strong adhesion to adjacent polymer layers, particularly, elastomers. In addition, the surfaces of the non-reactive ion beam treated fluoropolymer maintain large water contact angles, hydrophobicity, and low levels of leachable byproduct, unlike other surface treatment technologies.

### Example 12

A sample of skived PTFE is treated with a UV laser and bonded to SB Santoprene™. The peel strength of the sample is 1.2 ppi, whereas a sample formed from untreated skived PTFE and SB Santoprene™ exhibits a peel strength of approximately 0.1 ppi.

### Example 13

Skived PTFE films are treated with Na—NH₃ or an ion beam, as described above in relation to Example 1. The treated skived PTFE films are bonded to LSR silicone to form samples. The samples are dipped into liquid nitrogen for 24 hours, and then are fractures manually across the interface between the skived PTFE and the LSR silicone. The cross-sections are imaged using SEM techniques.

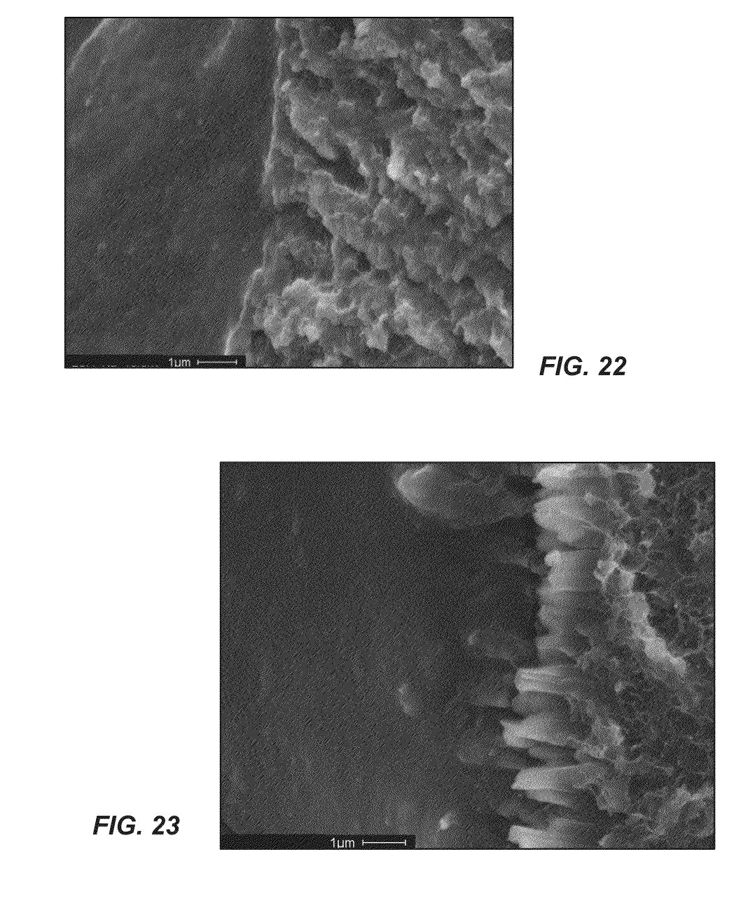

FIG. 22 illustrates that, the interface between the Na—NH₃ treated skived PTFE is relatively smooth. In contrast, FIG. 23 illustrates that the interface is rough and shows filament-like structures.

### Example 14

Septa are produced of a laminate of treated PTFE and HCR silicone. A laminate (6″ wide) is first produced by extruding a cold HCR ribbon on top of an ion beam treated skived PTFE film and squeezing the two layers together using two heated rolls at 270° F. The laminate is cured while remaining in contact with the heated roll for about 2 to 3 minutes. The laminate is then cut in septa parts of various sizes. The peel strength of non post-cured parts is 7.1 ppi. Better adhesion is expected following a 2-hour postcure treatment.

### Example 15

Laminates are produced by placing an ion beam or a Na—NH₃ treated skived PTFE film in a mold cavity (5″ by 5″) and injecting liquid silicone rubber (LSR) in the closed mold at 350° F. The shear rate induced by 6 cuin/s injection speed is over 20 s⁻¹. The residence time of the laminate in the mold is approximately 1 minute and the samples produced are not further postcured. The peel strength obtained in the case of the ion beam and the sodium ammonia treatments is 24.6 ppi and 24.4 ppi, respectively. Both samples exhibit cohesive failure of the substrate.

### Example 16

Laminates are prepared as previously described using compression molding technique of Example 2. Various elastomers are used as substrates. The thickness of the molded laminate is between 0.060″ and 0.065″, i.e., the thickness of a ¼″ ID by ⅜″ OD tube. The laminates are cut into 8″×1″ strips, folded in half longitudinally and placed in Masterflex easy load pump head. The pump head is set to a speed of 600 rpm until delamination occurs in the samples and the delamination spreads from the fold to the edge of the strip transversally. The peel strength of the samples before pumping and the pump life are recorded and are presented in the Table 11. The pump life targeted is 100 hours. After pumping for over 100 hours, the samples are stopped manually by the operator.

TABLE 11
Peel Strength and Pump Life for Samples

| | Initial Peel | Pump Life |
|---|---|---|
| | Strength (ppi) | (hours) |
| SB HCR/Na—NH₃ | — | 6 |
| SB HCR/Ion Beam | 22.2 (CF) | >100 |
| NSB LSR/Na-Naphthalene | — | >100 |
| NSB LSR/Ion Beam | 17.5 (CF) | >100 |
| SB Santoprene ™/Na—NH₃ | 11.5 (CF) | >100 |
| SB Santoprene ™/Ion Beam | 8.5 (CF) | >100 |
| C-Flex ® 374/Na—NH₃ | ~2 | n/a |
| C-Flex ® 374/Ion Beam | 15.8 (CF) | >100 |

### Example 17

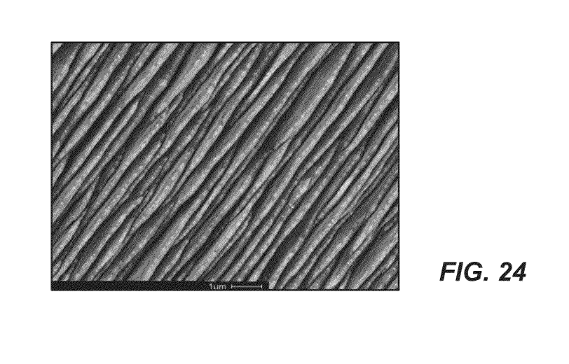

The outside of PTFE tubes are treated using an ion source in the same conditions as Example 1. The tubes are placed in a vacuum chamber and rotated in front of the source resulting in a striated structure, presenting striation across the surface of the tube aligned transversally as shown in FIG. 24. Following treatment, the tubes are slid on a steel mandrel and placed in a steel tube mold, forming cavities that are filled with uncured silicone rubber (HCR or LSR). The mold is then compressed following the same molding methods as applied when preparing slabs. The samples were post-cured and tested for peel strength using a 180° peel test. Table 12 illustrates the Peel Strength.

TABLE 12
Peel Strength in Tubes

| | Initial Peel |
|---|---|
| Jacket Material | Strength (ppi) |
| SB HCR | 14.05 (CF) |
| SB LSR | 7.40 (CF) |

Additional samples are formed from flattened treated tubes (i.e., cut in half longitudinally and flattened) over elastomers in a slab mold. The flattened tube samples provide comparable adhesion, illustrating that the structure of the surface obtained after ion beam treatment while rotating a tube in front of the source provides for desirable adhesion.

### Example 18

Slabs are molded as described above to produce laminates of ion beam treated paste extruded PTFE films and self-bonding silicone or Santoprene™. The samples are further post cured following the procedures described above, and peel strength is measured. Table 13 illustrates that excellent adhesion is obtained when paste extruded PTFE films are treated with non-reactive argon ion beam and a mixture of argon and oxygen gas, followed by bonding to silicone or Santoprene™ rubber.

TABLE 13
Peel Strength of Samples

| | Conditions of Ion Beam Treatment | | | |
|---|---|---|---|---|
| | Peel Strength (ppi) | | | |
| | 100% argon | | | |
| | (non- | 75% argon - | 50% argon - | 25% argon - |
| Substrate | reactive) | 25% oxygen | 50% oxygen | 75% oxygen |
| SB HCR (PC) | 54.05 (CF) | 46.46 (CF) | 41.07 (CF) | 52.86 (CF) |
| SB | 26.70 (CF) | 26.55 (CF) | 21.64 | 24.12 |
| Santoprene ™ | | | | |
| (PC) | | | | |

*CF—Cohesive Failure

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method of forming a polymeric article, the method comprising:
dispensing a first polymer layer comprising a low surface energy polymer and having a bond surface prepared with an ion beam treatment having an ion energy of 330 eV to 50 keV and an ion dose of 20 mC/cm² to 150 mC/cm² for a period of time of 5 seconds to 15 minutes; and
applying a second polymer layer to directly contact and adhere to the bond surface, wherein the second polymer layer is a diene elastomer, a thermoplastic olefinic elastomer, a silicone elastomer, or combination thereof.

2. The method of claim 1, wherein the ion energy is 400 eV to 10 keV, such as 667 eV to 5000 eV, or 1330 eV to 2000 eV.

3. The method of claim 1, wherein the ion dose is 60 mC/cm² to 97 mC/cm², such as 70 mC/cm² to 97 mC/cm², or 80 mC/cm² to 88 mC/cm².

4. The method of claim 1, wherein the period of time is 5 seconds to 10 minutes, such as 5 seconds to 1 minute, or 5 seconds to 30 seconds.

5. The method of claim 1, wherein the ion beam treatment is a non-reactive ion beam treatment.

6. The method of claim 1, wherein dispensing includes positioning the first polymer layer for application of the second polymer layer.

7. The method of claim 1, further comprising extruding the first polymer layer.

8. The method of claim 7, wherein extruding the first polymer layer comprises extruding the first polymer layer over a mandrel.

9. The method of claim 1, further comprising injection molding the first polymer layer.

10. The method of claim 1, wherein applying the second polymer layer comprises extruding the second polymer layer on the bond surface of the first polymer layer.

11. The method of claim 1, wherein applying further comprises curing the diene elastomer, the thermoplastic olefinic elastomer, the silicone elastomer, or combination thereof.

12. The method of claim 1, wherein applying the second polymer layer comprises injection molding the second polymer layer on the bond surface of the first polymer layer.

13. The method of claim 1, wherein the polymeric article exhibits a peel strength of at least 7 pound per inch (ppi), at least 10 ppi, or at least 14 ppi.

14. The method of claim 1, wherein the low surface energy polymer comprises a fluoropolymer selected from the group consisting of polytetrafluoroethylene (PTFE), a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), poly vinylidene fluoride (PVDF), polyvinyl fluoride (PVF), a terpolymer including tetrafluoroethylene, hexafluoropropylene, and vinylidenefluoride (THV), a terpolymer of tetrafluoroethylene, hexafluoroproplyene, and ethylene, and a combination thereof.

15. The method of claim 14, wherein fluoropolymer is polytetrafluoroethylene (PTFE), fluorinated ethylene propylene (FEP), a copolymer of perfluoroalkoxy (PFA), or any combination thereof.

16. The method of claim 1, wherein the low surface energy polymer includes a perfluoropolymer.

17. The method of claim 1, wherein the bond surface of the first polymer layer is substantially free of oxygenated species.

18. The method of claim 1, wherein the bond surface of the first polymer layer is substantially free of species that incorporate nitrogen.

19. The method of claim 1, wherein the polymeric article is a fluid conduit, the first polymer layer forming an inner surface of the fluid conduit.

20. A method of forming a polymeric article, the method comprising:
dispensing a first polymer layer comprising a fluoropolymer and having a bond surface prepared with an ion beam treatment having an ion energy of 330 eV to 50 keV and an ion dose of 20 mC/cm² to 150 mC/cm² for a period of time of 5 seconds to 15 minutes; and
applying a second polymer layer to directly contact and adhere to the bond surface, wherein the second polymer layer is a diene elastomer, a thermoplastic olefinic elastomer, a silicone elastomer, or combination thereof.
